(19) United States
(12) Patent Application Publication
(10) Pub. No.: US 2009/0124496 A1
(43) Pub. Date: May 14, 2009

(54) Attrition Resistant Particulate Catalyst

(76) Inventors: Gerardus Petrus Lambertus Niesen, Amsterdam (NL); Andre Harmen Sijpkes, Amsterdam (NL)

Correspondence Address: SHELL OIL COMPANY, P O BOX 2463, HOUSTON, TX, 772522463, US

(21) Appl. No.: 11/666,775

(22) PCT Filed: Nov. 2, 2005
(86) PCT No.: PCT/EP05/55701

§ 371 Date: May 1, 2007

(30) Foreign Application Priority Data
Nov. 3, 2004 (EP) 04105495.8

(51) Int. Cl. B01J 21/04

(52) U.S. Cl. 502/439; 502/325

(57) ABSTRACT

A spray dried particulate catalyst comprising a catalytically active component, a carrier and optionally a catalyst promoter, is described. The catalyst has a decrease in average particle diameter following the Shear Test as described herein of 25% or less. The fraction of catalyst particles being less than 10 μm in size, can also be less than 20%. The present invention also provides a method of manufacturing a particulate catalyst material comprising preparing an aqueous slurry, spray drying the aqueous slurry using a spray drier with an inlet temperature of less than 300° C., and calcining the particulate obtained. The invention has found that catalyst strength may be improved by careful manipulation of the spray drying conditions. In particular, it has been found that a catalyst that is spray dried at a relatively low gas inlet temperature, preferably in the range of 200° C. to 250° C., shows advantageous attrition characteristics (in terms of attrition resistance) compared to catalysts prepared by spray drying at higher temperatures.

The present invention relates to a catalyst, especially a spray dried catalyst. In particular, the invention relates to a spray dried catalyst for use in a three-phase slurry reaction, especially a Fischer-Tropsch reaction carried out in, for example, a three-phase slurry bubble column reactor.

The Fischer-Tropsch process can be used for the conversion of hydrocarbonaceous feed stocks into liquid and/or solid hydrocarbons. The feed stock (e.g. natural gas, associated gas, coal-bed methane biomass, residual oil fractions and/or coal) is converted in a first step into a mixture of hydrogen and carbon monoxide (this mixture is often referred to as synthesis gas or syngas). The synthesis gas is then converted in a second step over a suitable catalyst at elevated temperature and pressure into paraffinic compounds ranging from methane to high molecular weight molecules comprising up to 200 carbon atoms, or, under particular circumstances, even more.

Numerous types of reactor systems have been developed for carrying out the Fischer-Tropsch reaction. For example, Fischer-Tropsch reactor systems include fixed bed reactors, especially multitubular fixed bed reactors, fluidised bed reactors, such as entrained fluidised bed reactors and fixed fluidised bed reactors, and slurry bed reactors such as three-phase slurry bubble columns and ebulated bed reactors.

The Fischer-Tropsch reaction is very exothermic and temperature sensitive with the result that careful temperature control is required to maintain optimum operation conditions and desired hydrocarbon product selectivity. Bearing in mind the very high heat of reaction which characterises the Fischer-Tropsch reaction the mass transport, heat transfer characteristics and cooling mechanisms of a reactor are very important.

In a three-phase slurry bubble reactor catalyst particles are moving within a liquid continuous phase, resulting in efficient transfer of heat generated from catalyst particles to the cooling surfaces, while the large liquid inventory in the reactor provides a high thermal inertia, which helps prevent rapid temperature increases that can lead to thermal runaway. However, the constant motion of the catalyst particles leads to their attrition. Catalyst particle attrition has a negative impact on reactor performance generally and in particular (as the catalyst must be separated from reaction products) the present of fine catalyst particles represents a problem.

Thus, it is an important requirement for the catalyst to have resistance against attrition during its life in for example slurry Fischer-Tropsch reactor units. Attrition is a broad term denoting the unwanted break down or abrasion of particles when in a process. Generally, there is the ‘break-up’ of big particles into smaller particles, as well as the abrasion at the edge of particles which creates more ‘fines’. The greater the number of ‘fines’, the more likelihood of blockage of downstream filters.

The attrition of moving particulate material is determined by the properties of the catalyst particles (strength, size, shape, composition, etc) and by the properties of the environment (temperature, time, dispersion medium, viscosity, hydrodynamics (turbulence), mechanical impact, equipment designed, etc). Currently, there is no standard for measuring attrition.

It is one object of the present invention to provide a catalyst which is robust and which exhibits advantageous attrition characteristics, especially when used in a slurry bubble column reactor.

It is another object of the invention to provide a method of manufacturing a catalyst having advantageous attrition characteristics.

It is a further object of the invention to provide a catalyst with improved performance in the Fischer-Tropsch reaction, especially a slurry Fischer-Tropsch reactor.

The present invention provides a spray dried particulate catalyst comprising a catalytically active component, a carrier and optionally a catalyst promoter, wherein the decrease in average particle diameter of the catalyst following the Shear Test as described herein is 25% or less, preferably less than 20%, the particulate catalyst containing a catalytically active component, expressed as weight of pure metal on the weight of the carrier, in an amount up till 100 parts by weight per 100 parts by weight of carrier.

The present invention also provides a spray dried particulate catalyst comprising a catalytically active component, a carrier and optionally a catalyst promoter, wherein the fraction of the catalyst having a particle size of less than 10 μm following the Shear Test as described herein is less than 20%, the particulate catalyst containing a catalytically active component, expressed as weight of pure metal on the weight of the carrier, in an amount up till 100 parts by weight per 100 parts by weight of carrier.

The present invention also provides a spray dried particulate catalyst comprising a catalytically active component, a carrier and optionally a catalyst promoter, wherein the decrease in average particle diameter of the catalyst is 25% or less, preferably less than 20%, following exposure of the catalyst to a shear rate or velocity gradient in the range 900-1000 per second, the particulate catalyst containing a catalytically active component, expressed as weight of pure metal on the weight of the carrier, in an amount up till 100 parts by weight per 100 parts by weight of carrier.

The present invention also provides a spray dried particulate catalyst comprising a catalytically active component, a carrier and optionally a catalyst promoter, wherein the fraction of the catalyst having a particle size of less than 10 μm is less than 20% following exposure of the catalyst of a shear rate or velocity gradient of between 900 to 1000 per second.

The spray dried catalysts according to the present invention, especially as discussed in the four paragraphs above, are suitably obtained by spray drying of a slurry, especially an aqueous slurry, comprising all constituents, i.e. the catalytically active component or a precursor therefore, the carrier and optionally the catalyst promoter. The catalysts according to the invention are preferably calcined by temperatures between 300 and 1000° C., especially between 400 and 900° C. Calcination times are suitably within 1 minute and 2 hours, preferably between 3 minutes and 1 hour, more preferably between 5 and 30 minutes. Calcination can be done under an inert atmosphere or under air, or mixtures thereof. Air is preferred. It is observed that the catalyst properties as described above usually are obtained in one and the same experiment. As such, these properties may define one and the same catalyst in four different ways. In a preferred embodiment a catalyst is claimed in which the decrease in average particle diameter in the Shear Test is 25% or less, preferably less than 30%, and wherein in the same test the fraction of the catalyst having a particle size of less than 10 μm is less than 20%. In a further preferred embodiment the catalyst also shows a decrease in average particle diameter of the catalyst of 25% or less, preferably less than 30%, following exposure of the catalyst to a shear rate or velocity gradient in the range of 900-100, preferably 965, per second and/or wherein the fraction of the catalyst having a particle size of less than 10 μm of less than 20% following exposure to the above shear rate or velocity gradient. The catalyst according to the present invention is preferably a catalyst comprising a refractory oxide as carrier especially silica, alumina, titania or zirconia or mixtures thereof, more especially titania. Suitably at least 80 wt %, preferably at least 90 wt %, more preferably at least 95 wt % of the carrier is silica, alumina, titania, zirconia or mixtures thereof, especially, titania. In a further preferred embodiment the carrier is titania, optionally containing 5-30 wt % silica and/or alumina. The titania may be selected from rutile, anatese and brookite. The catalyst according to the invention is especially a Fischer-Tropsch catalyst. The catalytically component is usually iron or cobalt, especially cobalt. The promoter is especially selected from zirconium, manganese, vanadium, rhenium or platinum. The spray dried catalyst according to the invention are preferably calcined, as this further increases their strength.

The present invention also provides a method of manufacturing a particulate catalyst material comprising the steps of:

(1) preparing an aqueous slurry of a catalytically active component, a carrier and optionally a catalyst promoter;

(2) spray drying the aqueous slurry using a spray drier with an inlet temperature of less than 300° C., preferably less than 250° C.; and

(3) calcining the particulate obtained from step (2).

Generally, the spray drier temperature will be above 150° C., preferably at least above 200° C.

The calcination is suitably carried out at a temperature between 300 and 1000° C., preferably between 400 and 900° C.

The present invention also provides a particulate catalyst or particulate catalyst material whenever prepared by a method as herein described.

A preferred embodiment of the invention provides a particulate catalyst comprising a catalytically active component, a carrier and optionally a catalyst promoter wherein the catalyst is spray dried from an aqueous slurry at an inlet temperature of less than 300° C. and calcined in air at a temperature of at least 550° C.

The invention has found that catalyst strength may be improved by careful manipulation of the spray drying conditions. In particular, it has been found that a catalyst that is spray dried at a relatively low gas inlet temperature, preferably in the range of 200 to 250° C., shows advantageous attrition characteristics (in terms of attrition resistance) compared to catalysts prepared by spray drying at higher temperatures.

Spray drying is a well known technique. Usually is spray drier in a (larger) cylindrical chamber. In use the cylinder is mostly in a vertical position. The material to be dried is sprayed in the form of small droplets. A large volume of hot gas is fed into the cylinder. The amount of hot gas should be sufficient to supply the heat necessary to complete evaporation of the liquid. Heat transfer and mass transfer are accomplished by direct contact of the hot gas with the dispersed droplets. After completion of the drying, the cooled gas and solids are separated. This is usually accomplished at the bottom of the drying chamber. Any remaining fine particles may be separated from the gas stream in e.g. external cyclones or bag collectors. Also wet scrubbers may be used. Spray drying comprises three unit processes: liquid atomisation, gas-droplet mixing and drying of the liquid droplets. Atomisation may be carried out by using e.g. high-pressure nozzles, two-fluid nozzles or high speed centrifugal disks. The droplet size obtained is usually between 2 and 500 micron. Because of the large total drying surface created by the small droplets, the actual drying time in a spray drier is usually between 1 and 30 seconds, often between 2 and 20 seconds. The drying fluid is usually steam or air, preferably air. For an overview of spray dryers, reference is made to Perry's Chemical Enginees' Handbook, 6^{th} edition, 20-54 20-58.

In the process of the present invention suitably a (large) vertical cylindrical drying tower is used. The liquid used in the slurry is suitably water. Small amounts of organic liquids, e.g. methanol or ethanol, may be present. Pure water is preferred. The drying gas is suitably air. The droplet size is suitably between 10 and 500 micron, preferably between 20 and 200 micron. The residence time is suitably between 2 and 30 seconds, preferably between 4 and 12 seconds. The solids concentration in the slurry to be spray dried may vary over a wide range. Suitably the solids concentration is between 5 and 60 wt % of the total slurry weight, preferably between 10 and 40 wt %.

The components to be used for the preparation of the slurry may be commercially obtained. Carriers as silica, alumina, zirconia and/or titania providers are provided by several commercial producers. A suitable titania product is P25 sold by Degussa. Catalytical metal compounds are also available as powders from several commercial producers. Soluble components, e.g. iron nitrate, cobalt nitrate etc., may be used. Also insoluble compounds, e.g. cobalt hydroxide, cobalt hydroxy oxide, cobalt oxide, cobalt carbonate etc., may be used. The slurry is prepared by mixing the constituents, preferably by adding the solid components to a stirred aqueous phase. After mixing the slurry is dried, e.g. in a commercially available spray tower. The inlet temperature of the spray drier, i.e. the temperature of the drying gas, is below 300° C. The pressure in the spray tower is suitably ambient pressure, or, due to the evaporisaton of the liquid, slightly above ambient pressure. Other pressure, e.g. between 0.1 and 5 bar, especially between 0.5 and 2 bar may be used, however, ambient pressure is preferred. Residence time on the spray drier is suitably between 2 and 30 seconds, preferably between 10 and 20 seconds. The actual drying time is suitably between 1 and 25 seconds, preferably between 4 and 20 seconds, more preferably 6 to 15 seconds. The drying time may be estimated by varying the residence time. The particles are considered to be dry when the LOI is less than 5 wt %, preferably less than 2 wt %. It is observed that the shape of the particles obtained in the spray drying process is more or less spherical. This is due to the fact that the droplets made in the spraying part of the process quickly adopt a spherical shape, which form hardly changes during the drying process.

As starting materials especially refractory oxide powders are used. Preferred are powders having a particle size suitably between 1 nm and 100 micron, preferably between 1 and 1000 nm, especially between 2 and 500 nm, more especially between 3 and 200 nm, or even between 5 and 100 nm. The powders usually show BET surface area's between 10 and 500 m²/g, preferably between 20 and 300 m²/g. It is preferred to use metal or metal compound powders of the same size. The powders do not disclose in water at 25° C. or only to very small amounts. Using these small particle powders very active catalyst are obtained. The same effect may also be obtained by using soluble metal compounds. Directly precipitated metal compounds, e.g. hydroxides, oxides, and carbonates, are not used. In this way large solid masses are obtained with a relative low surface.

The optimum amount of the catalytically active metal on the carrier depends on the specific catalytically active metal. Typically, the amount of catalytically active metal, expressed as weight of pure metal on the weight of the carrier, varies between 1 to 100 parts by weight of metal per 100 parts by weight of carrier, preferably from 10 to 50 parts by weight per 100 parts by weight of carrier more preferably between 15 and 40 pbw per 100 pbw carrier. It is observed that metal catalysts containing a continuous phase of metal compounds in which a structural promoter is present are not included by the invention. In such catalyst the weight amount of pure metal is larger than the weight amount of structural promoter. Such types of catalyst are made by precipitation of a catalytically active metal compound. These catalysts, due to their low metal surface area show a relatively low productivity per gram metal. For that reason precipitated catalysts are excluded. The catalysts of the present invention comprise a continuous carrier phase with separate metal (compound) crystallites on the carrier.

Without wishing to be limited by theory, the Applicant believes that lowering the inlet temperature of the spray drying step reduces the rate of evaporation and, as a result of the slower rate of drying, the particles have more time to aggregate. For that reason it is preferred to use relatively long residence times in combination with a low gas temperature. This reduces the productivity of the spray drier to some extent, however, it results in an improved catalyst. In addition, calcination of the spray dried catalyst at a temperature above 300° C. is a further preferred embodiment.

The Shear Test is carried out as follows: an Ultra Turrax T50/S50N/G45F blending machine supplied by IKA operates a stirrer at a speed of 5750 rpm, which is equivalent with a shear rate of 965 s⁻¹. The stirrer has a G45F dispersing element, which has a rotor with an outer diameter of 40 mm, and a stator having an outer diameter of 45 mm and a inner diameter of 41 mm. Each of the rotor and stator have a series of vertical slits, whose width and height are 2 mm and 12 mm. The stirrer is located 18 mm from the base of a 250ml beaker having a height of 120 mm and an inner diameter of 55 mm. In the beaker is 100 ml aqueous sample comprising a catalyst concentrate of 5% v/v in 100 g of water. The beaker is secured in a thermostatic bath keeping the temperature at 20° C.±2° C. In testing, the stirrer is operated for 30 minutes. Preferably the shear rate is 965/sec.

The shear test can be performed on particles of less than about 500 μm. In case of larger particles to be tested, such particles can be crushed or otherwise reduced in size to a size of 500 μm or less.

Particle size distribution (PSD) measurements are carried out by means of Laser Light Diffraction (LLD). The apparatus is a Malvern Mastersizer Micro+. After completion of a sheer test, a representative sample is taken and its PSD measured. The two parameters that are used to define attrition are Average Particle Diameter (APD) and fr<10. APD is measured as the volume weighted average particle diameter, D(4, 3), or the De Broucker mean. Fr<10 is the volume fraction of particles having a diameter of <10 μm.

The attrition rate as used herein is defined as the per cent decrease in APD during a test. In addition the attrition rate is further defined as the absolute increase in the amount of particles having a diameter of less than 10 μm, the ‘fr<10’. The latter parameter gives additional and important information on the amount of so-called “fines” that may be formed during a test. Fines are detrimental to process operations in slurry as they may clog the filters which are used for catalyst/product separation in slurry operation.

The APD is defined as:

$$Δ ( A P D ) = \frac{A P {D}_{t = 0} - A P {D}_{t = 30}}{A P {D}_{t = 0}} * 100 ( \% )$$

The increase in fr<10 is defined as

Δ(fr<10)=[fr<10]ₜ₌₃₀−[fr<10]ₜ₌₀

In order to determine the repeatability of the test a series of tests was carried out. Repeatability is defined as: a value below which the absolute difference between two test results obtained with the same method on identical test material under the same conditions may be expected to lie with a specified probability. In the absence of other information, the confidence level is 95%. The relative standard deviations, for both parameters, are less than 5%.

The test also needs to be reliable over longer periods of time, i.e. the equipment should not show any signs of wearing down and attrition rate should remain constant. In order to verify that this is the case, a reference catalyst has been tested regularly, i.e. each (series of) test(s) was preceded by a reference test.

All catalysts are tested at 5% v/v concentration, i.e. the volume-based concentration, which is calculated using the following equation:

$$\% v / v = \frac{Mcat}{Mcat [ 1 - P V * P A D ] + [ M 1 / dL ] * P A D} * 100$$

Where Mcat is the mass of catalyst, ML is the mass of the liquid, dL is the density of the liquid, PV is the pore volume of the catalyst (in ml/g, measured manually by adding small amounts of water to a known mass of catalyst until wetness occurs,), and PAD is the particle density of the catalyst, calculated from PV and the skeletal density, SKD, of the catalyst:

$$P A D = \frac{1}{( 1 / S K D ) + P V} ( g \text{/} ml )$$

SKD=ΣMFi*di (g/ml)

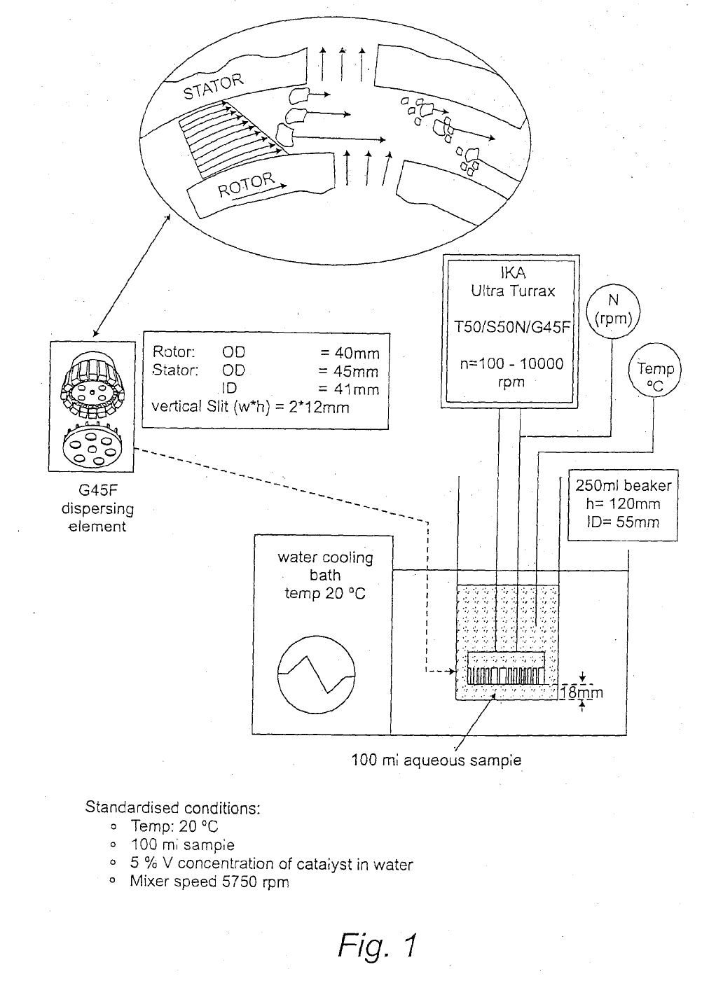

A pictorial representation of this test is shown in the accompanying drawing, FIG. 1.

The above test is reliable, simple, quick and efficient, being conveniently performed in water as the liquid medium at a temperature of 20° C. The test mimics the shear conditions occurring in a commercial process (pumploop, stirrers, other internals) by exposing the catalyst particles to a high shear mixer/disperser for a specified period of time. The change in the particle size distribution of the catalyst is a measure of its strength or attrition resistance. The test can be conducted with an estimated repeatability of better than ±5%.

The catalysts provided by the present invention are suitable for slurry reactions, in particular Fischer-Tropsch type reactions.

The Fischer-Tropsch synthesis is well known to those skilled in the art and involves synthesis of hydrocarbons from a gaseous mixture of hydrogen and carbon monoxide, by contacting that mixture at reaction conditions with a Fischer-Tropsch catalyst.

Products of the Fischer-Tropsch synthesis may range from methane to heavy paraffinic waxes. Preferably, the production of methane is minimised and a substantial portion of the hydrocarbons produced have a carbon chain length of a least 5 carbon atoms. Preferably, the amount of C₅+ hydrocarbons is at least 60% by weight of the total product, more preferably, at least 70% by weight, even more preferably, at least 80% by weight, most preferably at least 85% by weight. Reaction products which are liquid phase under reaction conditions may be separated and removed using suitable means, such as one or more filters. Internal or external filters, or a combination of both, may be employed. Gas phase products such as light hydrocarbons and water may be removed using suitable means known to the person skilled in the art.

The average particle size of the catalyst particles used in three-phase slurry reactors may very between wide limits, depending inter alia on the type of slurry zone regime. Typically, the average particle diameter may range from 1 μm to 2 mm, preferably from 1 μm to 1 mm.

If the average particle diameter is greater than 100 μm, and the particles are not kept in suspension by a mechanical device, the slurry zone regime is commonly referred to as ebullating bed regime. Preferably, the average particle diameter in an ebullating bed regime is less than 600 μm, more preferably in the range from 100 to 400 μm. It will be appreciated that in general the larger the particle size of a particle, the smaller the chance that the particle escapes from the slurry zone into the freeboard zone of the reactor. Thus, if an ebullating bed regime is employed, primarily fines of catalyst particles will escape to the freeboard zone.

If the average particle diameter is at most 100 μm, and the particles are not kept in suspension by a mechanical device, the slurry zone regime is commonly referred to as a slurry phase regime. Preferably, the average particle diameter in a slurry phase regime is more than 5 μm, more preferably in the range from 10 to 75 μm.

Fischer-Tropsch catalysts are known in the art, and typically include a Group VIII metal component, preferably cobalt, iron and/or ruthenium, more preferably cobalt. Typically, the catalyst comprises a catalyst carrier. The catalyst carrier is preferably porous, such as a porous inorganic refractory oxide, more preferably alumina, silica, titania, zirconia or mixtures thereof.

The optimum amount of catalytically active metal present on the carrier depends inter alia on the specific catalytically active metal. Typically, the amount of cobalt present in the catalyst may range from 1 to 100 parts by weight per 100 parts by weight of carrier material, preferably from 10 to 50 parts by weight per 100 parts by weight of carrier material.

The catalytically active metal may be present in the catalyst together with one or more metal promoters or co-catalysts. The promoters may be present as metals or as the metal oxide, depending upon the particular promoter concerned. Suitable promoters include oxides of metals from Groups IIA, IIIB, IVB, VB, VIB and/or VIIB of the Periodic Table, oxides of the lanthanides and/or the actinides. Preferably, the catalyst comprises at least one of an element in Group IVB, VB and/or VIIB of the Periodic Table, in particular titanium, zirconium, maganese and/or vanadium. As an alternative or in addition to the metal oxide promoter, the catalyst may comprise a metal promoter selected from Groups VIIB and/or VIII of the Periodic Table. Preferred metal promoters include rhenium, platinum and palladium.

A most suitable catalyst comprises cobalt as the catalytically active metal and zirconium as a promoter. Another most suitable catalyst comprises cobalt as the catalytically active metal and maganese and/or vanadium as a promoter.

The promoter, if present in the catalyst, is typically present in an amount of from 0.1 to 60 parts by weight per 100 parts by weight of carrier material. It will however be appreciated that the optimum amount of promoter may vary for the respective elements which act as promoter. If the catalyst comprises cobalt as the catalytically active metal and maganese and/or vanadium as promoter, the cobalt: (maganese+vanadium) atomic ratio is advantageously at least 12:1.

The concentration of catalyst particles present in the slurry may range from 5 to 45% by volume, preferably, from 10 to 35% by volume. It may be desired to add in addition other particles to the slurry, as set out in for example European Patent Publication No. 0 450 859. The total concentration of solid particles in the slurry is typically not more than 50% by volume, preferably not more than 45% by volume.

Suitable slurry liquids are known to those skilled in the art. Typically, at least a part of the slurry liquid is a reaction product of the exothermic reaction. Preferably, the slurry liquid is substantially completely a reaction product.

The Fischer-Tropsch synthesis is preferably carried out at a temperature in the range from 125 to 350° C., more preferably 175 to 275° C., most preferably 200 to 260° C. The pressure preferably ranges from 5 to 150 bar abs., more preferably from 5 to 80 bar abs.

Hydrogen and carbon monoxide (synthesis gas) is typically fed to the three-phase slurry reactor at a molar ratio in the range from 0.4 to 2.5. Preferably, the hydrogen to carbon monoxide molar ration is in the range from 1.0 to 2.5.

The gaseous hourly space velocity may very within wide ranges and is typically in the range from 1500 to 10000 Nl/l/h, preferably in the range from 2500 to 7500 Nl/l/h.

The Fischer-Tropsch synthesis is preferably carried out in a slurry phase regime or an ebullating bed regime, wherein the catalyst particles are kept in suspension by an upward superficial gas and/or liquid velocity.

It will be understood that the skilled person is capable to select the most appropriate conditions for a specific reactor configuration and reaction regime.

Preferably, the superficial gas velocity of the synthesis gas is in the range from 0.5 to 50 cm/sec, more preferably in the range from 5 to 35 cm/sec.

Typically, the superficial liquid velocity is kept in the range from 0.001 to 4.00 cm/sec, including liquid production. It will be appreciated that he preferred range may depend on the preferred mode of operation.

According to one preferred embodiment, the superficial liquid velocity is kept in the range from 0.005 to 1.0 cm/sec.

The invention further relates to the use of a catalyst as described above in a hydroconversion process, a hydrogenation process, a hydrocarbon synthesis reaction or in the purification of exhaust gases, preferably in a hydrocarbon synthesis process, the Fischer-Tropsch process. The invention also relates to a process for the preparation of normally gaseous, normally liquid and optionally normally solid hydrocarbons from synthesis gas, by contacting the synthesis gas at elevated temperature and pressure with a catalyst as described above. This process is preferably carried out in a slurry phase reaction, more particularly a Fischer-Tropsch reaction. In such a slurry process the catalyst shows improved properties, especially with respect to attrition, but also to properties as selectivity to C₅+ products, activity and/or stability when compared with catalysts of the same particle size and/or made from the same starting materials but spray dried above 300° C. The invention also relates to the products made in the hydrocarbon synthesis process, as well as to any products obtained in the hydrogenation, hydroisomerisation and/or hydrocracking of the direct product. Examples of these products are naphtha, keso, gasoil, n-paraffins, waxy raffinate base oils and/or wax.

### EXAMPLES

The data set out in Table 1 compares the attrition characteristics of a number of catalysts prepared by spray drying under various inlet temperature conditions. Each catalyst underwent calcination (in air at 550° C.) after spray drying. In each case the catalyst material comprised TiO 71.8%, Co 19.9% and Mn 0.67%.

TABLE 1

| | Tᵢₙₗₑₜ | APD | Δ(APD) | Δ(Fr < 10) |
|---|---|---|---|---|
| Example | (° C.) | (μm) | (%) | (% v) |
| 1 | 370 | 27 | 29 | 24 |
| 2 | 300 | 30 | 26 | 22 |
| 3 | 250 | 32 | 21 | 19 |
| 4 | 200 | 29 | 19 | 19 |

^{T}inlet is the inlet temperature of the spray drier; APD is the average particle diameter (after spray drying and calcination); Δ(APD) is the change in average particle diameter after exposure of the catalyst to shear; and Δ(Fr<10) is the fraction having a particle size of less than 10 μm.

The data set out in Table 1 illustrates that the spray drying conditions employed have an impact on the catalyst particle strength, in particular, particulates produced at an inlet temperature of less than 300° C. exhibit advantageous attrition resistance characteristics, as illustrated by the low Δ(APD) and Δ(Fr<10) figures for Examples 3 and 4.

1. A spray dried particulate catalyst comprising a catalytically active component and a carrier, wherein the carrier is a porous inorganic refractory oxide, and wherein the decrease in average particle diameter of the catalyst following a Shear Test as described herein is 25% or less, the particulate catalyst containing a catalytically active component, expressed as weight of pure metal on the weight of the carrier, in an amount up to 100 parts by weight per 100 parts by weight of carrier.

2. A spray dried particulate catalyst comprising a catalytically active component and a carrier, wherein the carrier is a porous inorganic refractory oxide, and wherein the fraction of the catalyst having a particle size of less than 10 μm following a Shear Test as described herein is less than 20%, the particulate catalyst containing a catalytically active component, expressed as weight of pure metal on the weight of the carrier, in an amount up to 100 parts by weight per 100 parts by weight of carrier.

3. A spray dried particulate catalyst comprising a catalytically active component and a carrier, wherein the carrier is a porous inorganic refractory oxide, and wherein the decrease in average particle diameter of the catalyst is 25% or less following exposure of the catalyst to a shear rate or velocity gradient in the range 900-1000 per second the particulate catalyst containing a catalytically active component, expressed as weight of pure metal on the weight of the carrier, in an amount up to 100 parts by weight per 100 parts by weight of carrier.

4. A spray dried particulate catalyst comprising a catalytically active component and a carrier, wherein the carrier is a porous inorganic refractory oxide, and wherein the fraction of the catalyst having a particle size of less than 10 μm is less than 20% following exposure of the catalyst to a shear rate or velocity gradient of between 900 to 1000 per second the particulate catalyst containing a catalytically active component, expressed as weight of pure metal on the weight of the carrier, in an amount up to 100 parts by weight per 100 parts by weight of carrier.

5. A spray dried particulate catalyst according to claim 1, in which the catalyst has been calcined at a temperature above 300° C.

6. A method of manufacturing a particulate catalyst as comprising the steps of:
(1) preparing an aqueous slurry of a catalytically active component and a carrier, the carrier being a porous inorganic refractory oxide;
(2) spray drying the aqueous slurry using a spray drier with an inlet temperature of less than 300° C.; and
(3) calcining the particulate obtained from step (2) wherein the decrease in average particle diameter of the catalyst following a Shear Test as described herein is 25% or less.

7. A catalyst according to claim 1, wherein the average particle diameter is from about 1 μm to about 2 mm.

8. A catalyst according to claim 1, wherein the catalytically active component comprises a Group VIII metal.

9. A catalyst according to claim 1, wherein the carrier is selected from the group consisting of alumina, silica, titania, zirconia and mixtures thereof.

10. A catalyst according to claim 1, further comprising a promoter, wherein the promoter is a metal, selected from the group consisting of Group IIA, IIIB, IVB, VB, VIB, VIIB, the lanthanide group or the actinide group of the periodic table, or an oxide thereof.

11. A catalyst according to claim 1, comprising cobalt as the catalytically active material and a promoter selected from the group consisting of zirconium, manganese, vanadium and mixtures thereof.

12. (canceled)

13. A catalyst according to claim 2, wherein the catalytically active component comprises a Group VIII metal.

14. A catalyst according to claim 3, wherein the catalytically active component comprises a Group VIII metal.

15. A catalyst according to claim 4, wherein the catalytically active component comprises a Group VIII metal.

16. A catalyst according to claim 2, further comprising a promoter, wherein the promoter is a metal, selected from the group consisting of Group IIA, IIIB, IVB, VB, VIB, VIIB, the lanthanide group or the actinide group of the periodic table, or an oxide thereof.

17. A catalyst according to claim 3, further comprising a promoter, wherein the promoter is a metal, selected from the group consisting of Group IIA, IIIB, IVB, VB, VIB, VIIB, the lanthanide group or the actinide group of the periodic table, or an oxide thereof.

18. A catalyst according to claim 4, further comprising a promoter, wherein the promoter is a metal, selected from the group consisting of Group IIA, IIIB, IVB, VB, VIB, VIIB, the lanthanide group or the actinide group of the periodic table, or an oxide thereof.

19. A catalyst according to claim 2, comprising cobalt as the catalytically active material and a promoter selected from the group consisting of zirconium, manganese, vanadium and mixtures thereof.

20. A catalyst according to claim 3, comprising cobalt as the catalytically active material and a promoter selected from the group consisting of zirconium, manganese, vanadium and mixtures thereof.

21. A catalyst according to claim 4, comprising cobalt as the catalytically active material and a promoter selected from the group consisting of zirconium, manganese, vanadium and mixtures thereof.
